(19) United States
(12) Patent Application Publication
(10) Pub. No.: US 2009/0319982 A1
(43) Pub. Date: Dec. 24, 2009

(54) Multiple Code Inheritance with Explicit Base Calling

(75) Inventors: Simon J. Hall, Seattle, WA (US); Nigel Perry, Bothel, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/145,094

(22) Filed: Jun. 24, 2008

(51) Int. Cl. G06F 9/44

(52) U.S. Cl. 717/104

(57) ABSTRACT

Embodiments described herein are directed to extending a software interface to include non-public functions. In one embodiment, a computer system receives a user input indicating that an interface is to be used to manage code inheritance in the generation of a software application. The interface includes a public functions declaration identifying functions that are publicly available to generate an application. The computer system determines that the received indication indicates that a non-public function is to be used in addition to any public functions, where the non-public function is accessible through the interface. The computer system also generates a software application using the non-public function and a public function, as indicated in the received user input.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

Software application code is often written in modules which may be may be used by software developers in other applications. For example, a developer may write generic code for performing a process such as preparing a document for printing. Other developers may use the same code in their programs to prepare documents for printing. Moreover, software code may be configured to inherit data or code from other sources. For example, a developer may indicate in a program that a code module is to be inherited from a local or remote source. Data may be received from other applications or other modules within applications. Similarly, code may be inherited from other sources.

Typically, software programs implement interfaces that specify in a public declaration which modules or functions are available through that interface. However, because the declarations are public, calls to the referenced functions may also be publicly visible.

### BRIEF SUMMARY

Embodiments described herein are directed to extending a software interface to include non-public functions. In one embodiment, a computer system receives a user input indicating that an interface is to be used to manage code inheritance in the generation of a software application. The interface includes a public functions declaration identifying functions that are publicly available to generate an application. The computer system determines that the received indication indicates that one or more functions specified in the interface's public functions declaration are to be used in the generation of the software application and determines that the received indication indicates that a non-public function is to be used in addition to any public functions, where the non-public function is accessible through the interface. The computer system also generates a software application using the non-public function and a public function, as indicated in the received user input.

In another embodiment, a computer system enables an interface to declare a private function such that the private function is configured to receive a corresponding function body from the implementing type. The computer system receives an indication that an interface is to be used to manage code inheritance in the generation of a software application. The interface includes a private function that is configured to receive a corresponding function body from an implementing type. The implementing type implements the interface to access the private function. The computer system indicates to the implementing type that the implementing type is to provide the function body corresponding to the accessed private function and receives from the implementing type the function body corresponding to the accessed private function. The computer system also implements the private function and the received function body in the generation of the software application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including extending a software interface to include non-public functions.

FIG. 2 illustrates a computer architecture in which embodiments of the present invention may operate including enabling an interface to declare a private function that receives a corresponding function body from the implementing type.

FIG. 3 illustrates a flowchart of an example method for extending a software interface to include non-public functions.

FIG. 4 illustrates a flowchart of an example method for enabling an interface to declare a private function that receives a corresponding function body from the implementing type.

### DETAILED DESCRIPTION

Embodiments described herein are directed to extending a software interface to include non-public functions. In one embodiment, a computer system receives a user input indicating that an interface is to be used to manage code inheritance in the generation of a software application. The interface includes a public functions declaration identifying functions that are publicly available to generate an application. The computer system determines that the received indication indicates that one or more functions specified in the interface's public functions declaration are to be used in the generation of the software application and determines that the received indication indicates that a non-public function is to be used in addition to any public functions, where the non-public function is accessible through the interface. The computer system also generates a software application using the non-public function and a public function, as indicated in the received user input.

In another embodiment, a computer system enables an interface to declare a private function such that the private function is configured to receive a corresponding function body from the implementing type. The computer system receives an indication that an interface is to be used to manage code inheritance in the generation of a software application. The interface includes a private function that is configured to receive a corresponding function body from an implementing type. The implementing type implements the interface to access the private function. The computer system indicates to the implementing type that the implementing type is to provide the function body corresponding to the accessed private function and receives from the implementing type the function body corresponding to the accessed private function. The computer system also implements the private function and the received function body in the generation of the software application.

Embodiments of the present invention may comprise or utilize a special purpose or general-purpose computer including computer hardware, as discussed in greater detail below. Embodiments within the scope of the present invention also include physical and other recordable-type computer-readable storage media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

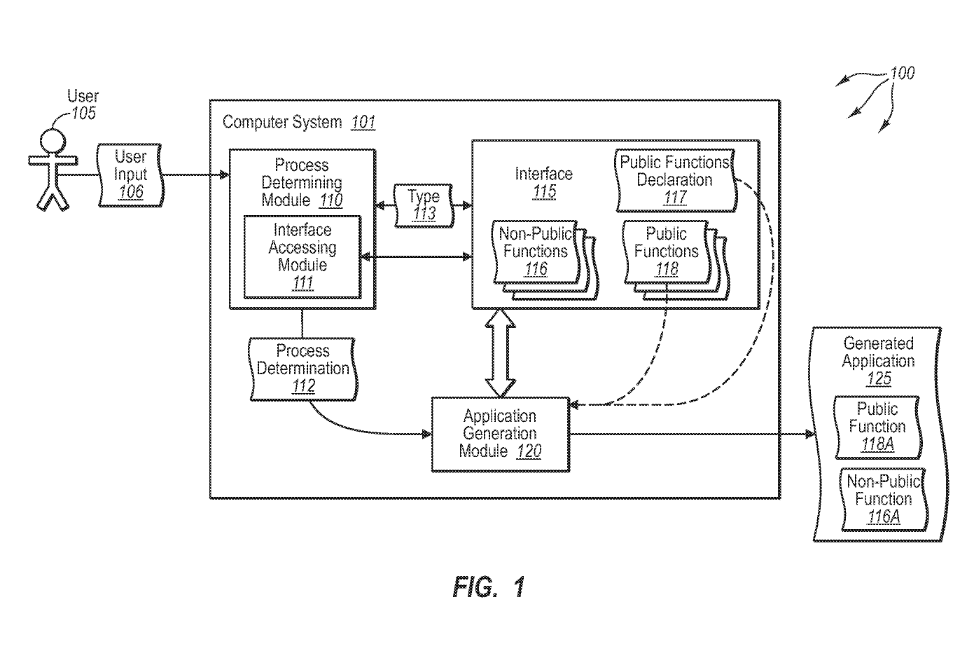

FIG. 1 illustrates a computer architecture 100 in which the principles of the present invention may be employed. Computer architecture 100 includes computer system 101. In some embodiments, computer system 101 may be configured to receive user input 106 from user 105. User 105 may be any type of computer user including an end-user, a software developer, administrator, or other user. User input 106 may be received from a local computer system or from a remote source, such as over a computer network. Process determining module 110 may be configured to receive user input 106 and access interface 115 as appropriate.

Interface 115 may be any type of software interface configured to describe a set of available functionality such as public functions. Typically, an interface does not provide the actual functionality implementations (e.g. code bodies), but rather provides a contract or declaration indicating how the functionality may be accessed. For example, interface 115 may identify public functions 118 and/or non-public functions 116 and provide a contract or other indication of how the functions may be accessed. In some cases, the functions themselves (i.e. the function bodies) may be provided by the type or class that implements the interface (e.g. type 113). This process is referred to herein as an implementing type providing a function's implementation.

In some cases, public functions declaration 117 may list or otherwise indicate those public functions that are available to types that implement interface 115 (e.g. type 113). In some cases, public functions 118 may include code modules or portions that are publicly available for others to use. For example, many software functions are redundant, or may be used in multiple different applications to perform the same function. Thus, a print function that prepares a document for printing may be used in a word processing application as well as a home design application. It should be understood that this is merely one small example among many possible examples. Code or code modules may be used or inherited in this manner, from other applications or from a central repository of code modules. This allows the developer to concentrate on his or her application-specific portions and less on generic portions that could be borrowed or inherited from other sources.

In some cases, it may be desirable to implement functions in an interface that are not publicly available. Thus, interface 115 may include, have access to, or provide a contract for non-public functions 116. These functions may be accessible only to interface 115 and not to other interfaces. Moreover, non-public functions may be accessed by the public functions whose definitions (or code bodies) are in (or accessible through) interface 115. In some embodiments, interface 115 does not provide access to non-public functions 116 for any function definition outside of the interface. This affords an increased level of privacy and security because the functions are not publicly available. Interface accessing module 111 may be configured to access interface 115 as well as other interfaces that may be available to computer system 101. Process determining module 110 may be configured to interact with interface accessing module 110 to make various determinations concerning interfaces, functions and various other processes. These determinations (e.g. process determinations 112) may be sent to application generation module 120 to aid in the application generation process.

As used herein, the term “inheritance” generally refers to a subtype or subclass inheriting features or functionality from a parent-, base- or super-class. “Multiple code inheritance” (MCI), as used herein, may refer to an interface being able to define some or all of its own function bodies. As indicated above, interfaces may be extended to define some of the function bodies referenced in the interface's functionality declaration or contract. Due to MCI, an implementing type's ability to provide a preferred implementation (i.e. function body) may not be affected. In some cases, an implementing type or class may be able to implement an interface to directly (i.e. non-virtually) invoke a non-abstract function (i.e. an interface function that has a definition/function body). This process may be referred to herein as “base calling.” This may allow a type to supplement but still leverage the interface-provided functionality.

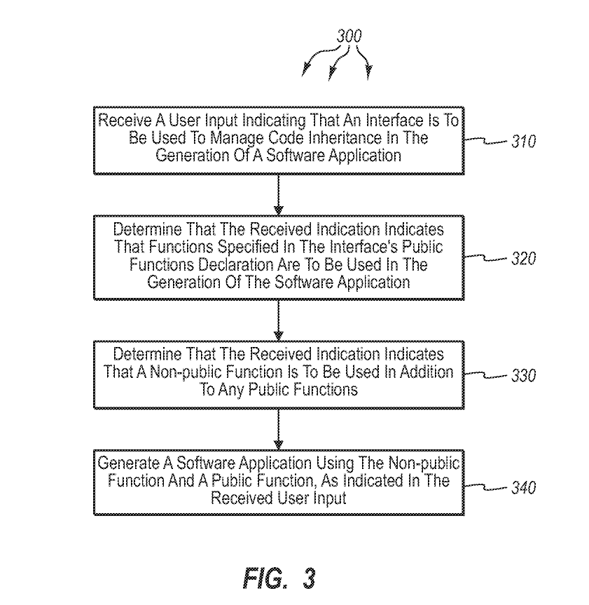

Typically, a developer's goal is to develop a working software function, module or application. Application generation module 120 may be configured to access either or both of public functions 118 and non-public functions 116 during the application generation process. In some cases, an application may be comprised of a plurality of code functions or modules. Module 120 may combine these functions to create a working software application. Module 120 may access these functions before or during the application generation process, and may consult public functions declaration 117 to determine which public functions are available for use in application creation. In this manner, code from a variety of sources, including non-public functions accessible only through interface 115, may be used in the generation of an application. The resulting generated application 125 may include any or all of public function 118A, non-public function 116A and any other functions. It should be understood that although 118A and 116A are shown in the singular form, each may include one or more functions, as well as functions written by user 105. This process will be explained in greater detail below in connection with method 300 of FIG. 3.

FIG. 3 illustrates a flowchart of a method 300 for extending a software interface to include non-public functions. The method 300 will now be described with frequent reference to the components and data of environment 100 of FIG. 1.

Method 300 includes an act of receiving a user input indicating that an interface is to be used to manage code inheritance in the generation of a software application, where the interface includes a public functions declaration identifying functions that are publicly available to generate an application (act 310). For example, process determining module 110 may receive user input 106 indicating that interface 115 is to be used to manage code inheritance in the generation of a software application (e.g. generated application 125). Interface 115 includes (or has access to) public functions declaration 117 that identifies public functions 118 that are publicly available to generate an application. As explained above, public functions 118 may be any type of code functions, methods, modules, or other code portions.

In some cases, interface 115 may include one or more function implementations. This allows the interface to provide access a variety of application functions. For example, public functions available to interface 115 may be listed or identified in public functions declaration 117. Declaration 117 (and/or interface 115) may also identify one or more features which a class implementing the interface is to provide. Thus, in cases where a software class or type (e.g. type 113) is to implement interface 115, declaration 117 may identify various features which that class or type is to provide in order to use the interface.

Method 300 includes an act of determining that the received indication indicates that one or more functions specified in the interface's public functions declaration are to be used in the generation of the software application (act 320). For example, process determining module 110 may determine that user input 106 indicates that at least one public function 118 specified in public functions declaration 117 may be used in the generation of software application 125. Thus, user 105 may specify, in one or more indications, which functions are to be used in the generation of a software application.

Method 300 includes an act of determining that at least one non-public function is to be used in addition to any public functions, where the non-public function is accessible through the interface (act 330). For example, process determining module 110 may determine that at least one of non-public functions 116 is to be used in addition to any public functions 118, the non-public function being accessible through interface 115. Thus, in some cases, an implementing type may use non-public functions 116 in addition to any selected public functions. In some embodiments, interface 115 may also be configured to provide a function implementation for the non-public function. The non-public function may, for example, be a customized function designed to perform a function in a particular manner, as designed by a software developer. In some embodiments, the non-public function is accessible only by interface 115 and may be available to interact with other functions only through the interface. Additionally, it should be understood that, at least in some embodiments, an interface may include only public functions and may or may not include non-public functions.

As mentioned above, a type or class may implement interface 115. In some cases, interface 115 may provide a contract indicating one or more public and/or private features that are to be met by the type or class in order to implement the interface. In some cases, user 105 may be able to implement either or both of the private feature and the different feature in an interface implementation, such that either or both are to be met by an implementing type.

Method 300 includes an act of generating a software application using the non-public function and at least one public function, as indicated in the received user input (act 340). For example, application generation module 120 may generate software application 125 using non-public function 116A and public function 118A, as indicated by user 105 in input 106. Application generation module 120 may be configured to combine code functions or modules into a working application. These functions may be gathered from other applications or other sources, and may be made available through interface 115 or through other interfaces.

For example, interface accessing module 111 may be able to remotely access other interfaces and other functions through those interfaces over a computer network. In some embodiments, application generation module 120 may able to communicate directly with public functions declaration 117, public functions 118 to retrieve those functions that are to be implemented in application 125. Thus, code may be assembled from a variety of sources, and may include private or non-public functions available (exclusively) through interface 115. Interface 115 may be implemented to access these functions, and may, in some cases, include function implementations for the implementing type. Thus, in some embodiments, methods available through interface 115 may get their implementation either from interface 115 itself or from an implementing type that is implementing interface 115.

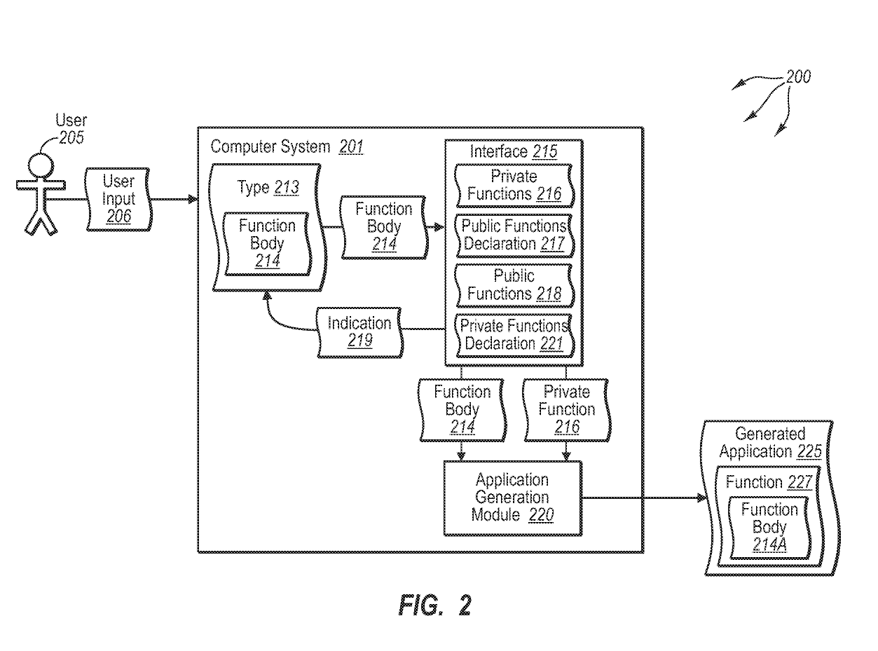

FIG. 2 illustrates a computer architecture 200 similar to architecture 100 of FIG. 1 in which the principles of the present invention may be employed. Computer architecture 200 includes computer system 201. In some embodiments, computer system 201 may be configured to receive user input 206 from user 205. It should be understood that some elements of architecture 200 may be similar to or the same as those described in reference to architecture 100. On the other hand, the elements may be different, depending on the implementation and desired uses.

Interface 215 may include private functions 216 that are available only to and through interface 215. In some cases, where a type or class (e.g. type 213) is to implement interface 215, public functions declaration 217 may specify one or more type features that are to be met in order to use interface 215. These features may include specific rules or objects that are to be followed or provided to interface 215 when attempting to implement the interface. As above, interface 215 may include or have access to public functions declaration 217 and public functions 218. These may be stored locally on computer system 201, or may be available remotely over a computer network such as a local area network, wide area network or the internet. Type 213 may include one or more function bodies 214 that may be sent to interface 215 for use in conjunction with private functions 216.

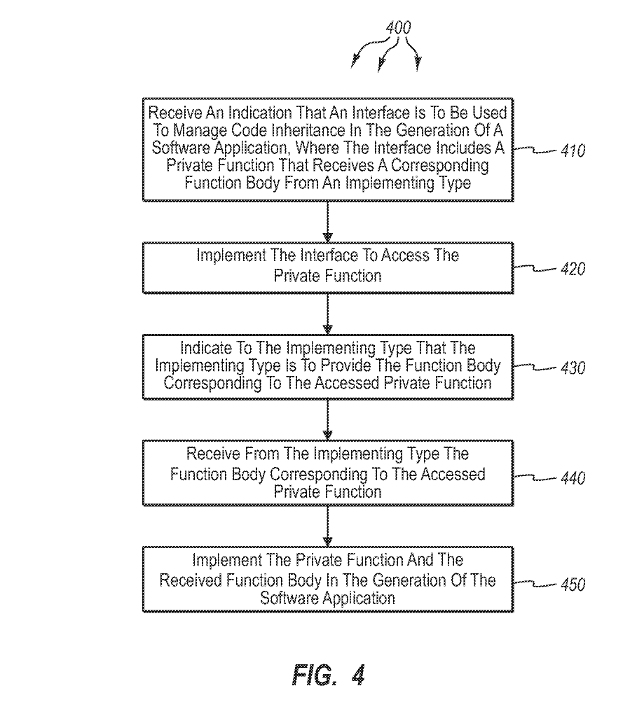

In some embodiments, interface 215, or more specifically, private functions declaration 221, may indicate to type 213 in indication 219 that type 213 is to provide a function body for private function 216. This function body (e.g. 214) may be used to supplement or override any existing function bodies in private functions 216. Function body 214, along with private function 216 and any public functions used may be sent to application generation module 220 to generate application 225 including at least one function 227 with the implemented function body 214A. This process will be explained in greater detail below in reference to method 400 of FIG. 4.

FIG. 4 illustrates a flowchart of a method 400 for enabling an interface to declare a private function that receives a corresponding function body from the implementing type. The method 400 will now be described with frequent reference to the components and data of environment 200 of FIG. 2.

Method 400 includes an act of receiving an indication that an interface is to be used to manage code inheritance in the generation of a software application, the interface including a private function that is configured to receive a corresponding function body from an implementing type (act 410). For example, computer system 201 may receive user input 206 indicating that interface 215 is to be used to manage code inheritance in the generation of application 225. Interface 215 may include private function 216 that is configured to receive function body 214 from type 213. Thus, in cases where type 213 is implementing interface 215, type 213 may provide one or more function bodies 214 for private function 216 (i.e. provide private function 216's implementation). In some embodiments, function body 214 may be used in addition to other (existing) function bodies. In other cases, body 214 may be used as an alternative to existing function bodies, and in such cases, override one or more existing function bodies. In this manner, existing private function bodies may be overridable by those provided by an implementing type.

Method 400 includes an act of the implementing type implementing the interface to access the private function (act 420). For example, type 213 may implement interface 215 to access private function 216. In some embodiments, type 213 may only be able to access private function 216 in order to provide the function body for the private function. In some cases, private function 216 may only be accessible to interface 215. Type 213 may also be able to access public functions 218. These functions may be accessible to type 213 when type 213 meets the features or other elements indicated in public functions declaration 217, as indicated above.

Method 400 includes an act of indicating to the implementing type that the implementing type is to provide the function body corresponding to the accessed private function (act 430). For example, interface 215 may indicate to implementing type 213 in indication 219 that type 213 is to provide a function body for private function 216. As indicated previously, function body 214 may be used as the sole function body for private function 216. Additionally or alternatively, body 214 may be used to supplement or override existing function bodies of private function 216. Thus, interface 215 may or may not provide its own function body for a private function, and can optionally mark the private function as being overridable by other private function bodies.

Method 400 includes an act of receiving from the implementing type the function body corresponding to the accessed private function (act 440). For example, interface 215 may receive function body 214 from type 213, where the function body corresponds to accessed private function 216. In some embodiments, an implementing type may include a variety of function bodies that correspond to a variety of different private (and/or public) functions. In such cases, function bodies that correspond to the functions of interface 215 are selected to be used as those functions' bodies.

Method 400 includes an act of implementing the private function and the received function body in the generation of the software application (act 440). For example, application generation module 220 may implement private function 216 and received function body 214 in the generation of application 225. In some cases, the functions may be inherited from other applications or code sources. The functions may be combined, in addition to any user-developed functions, to create a working software application (e.g. application 225).

In one embodiment, computer system 201 may receive user input 206 indicating that interface 215 is to be used to manage code inheritance in the generation of software application 225. Interface 215 may include public functions declaration 217 identifying functions that are publicly available to generate an application and features 221 which a type (e.g. type or class 213) implementing the interface is to provide. Process determining module 110 may determine that the received indication (e.g. user input 206) indicates that one or more functions (e.g. public functions 218 specified in the interface's public functions declaration 217 are to be used in the generation of software application 225.

The features identified in public functions declaration 217 may be implemented by a type or class that includes a vtable. Process determining module 110 may further determine that at least one non-public function (e.g. 216) of a type is to be used in addition to any public functions, where the non-public function is accessible (only) from within interface 215. Type 213 may access interface 215 to implement non-public functions from the interface, meeting the features included in contract 219 of the interface. Application generating module 220 may generate software application 225 using the non-public function of the type including the features of the contract of the interface and at least one public function, as indicated in received user input 206. Thus, an application may be generated using functions accessed through an interface. Some of the functions may be interface-specific, non-public functions available only to interface 115/215.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system in a computer networking environment, a method for extending a software interface to include non-public functions, the method comprising:
an act of receiving a user input indicating that an interface is to be used to manage code inheritance in the generation of a software application, the interface including a public functions declaration identifying functions that are publicly available to generate an application;
an act of determining that the received indication indicates that one or more public functions specified in the interface's public functions declaration are to be used in the generation of the software application;
an act of determining that the received indication indicates that at least one non-public function is to be used in addition to any public functions, the non-public function being accessible through the interface; and
an act of generating a software application using the non-public function and the at least one public function, as indicated in the received user input.

2. The method of claim 1, wherein the interface comprises one or more function implementations.

3. The method of claim 1, wherein the public function declaration identifies one or more features which a class implementing the interface is to provide.

4. The method of claim 1, wherein the non-public function is accessible only to the interface.

5. The method of claim 4, wherein a class implementing the interface invokes at least one non-abstract function.

6. The method of claim 5, wherein the non-abstract function includes a function body.

7. The method of claim 6, wherein the class implementing the interface provides a function body for the private function.

8. The method of claim 1, wherein the interface further provides the non-public function's implementation.

9. The method of claim 7, further comprising marking the private function to indicate that the private function is overridable by a private function body.

10. At a computer system in a computer networking environment, a method for enabling an interface to declare a private function such that the private function is configured to receive a corresponding function body from the implementing type, the method comprising:
an act of receiving an indication that an interface is to be used to manage code inheritance in the generation of a software application, the interface including a private function that is configured to receive a corresponding function body from an implementing type;
an act of the implementing type implementing the interface to access the private function;
an act of indicating to the implementing type that the implementing type is to provide the function body corresponding to the accessed private function;
an act of receiving from the implementing type the function body corresponding to the accessed private function; and
an act of implementing the private function and the received function body in the generation of the software application.

11. The method of claim 10, wherein the private function is only accessible to other functions in the same interface.

12. The method of claim 10, wherein source code for the generated application is inherited from a plurality of sources.

13. The method of claim 11, wherein the received function body overrides any corresponding overridable function body provided by the interface.

14. The method of claim 10, wherein the private function is accessible only to the interface.

15. The method of claim 10, wherein the private function is marked as being overridable by private function bodies.

16. The method of claim 10, wherein the implementing type implements the interface in a non-virtual manner to invoke a non-abstract function.

17. The method of claim 16, wherein the invocation of a non-abstract function allows the implementing type to incorporate and supplement interface-provided functionality.

18. The method of claim 10, wherein a plurality of function bodies are received from the implementing type.

19. A computer program product for implementing a method for extending a software interface to include non-public functions, the computer program product comprising one or more computer-readable media having thereon computer-executable instructions that, when executed by one or more processors of the computing system, cause the computing system to perform the method, the method comprising:
an act of receiving a user input indicating that an interface is to be used to manage code inheritance in the generation of a software application, the interface including a public functions declaration identifying functions that are publicly available to generate an application and features which a type implementing the interface is to provide;
an act of determining that the received indication indicates that one or more functions specified in the interface's public functions declaration are to be used in the generation of the software application, the features identified in the public functions declaration being implemented by a type that includes a vtable;
an act of determining that at least one non-public function of a type is to be used in addition to any public functions, the non-public function being accessible through the interface;
an act of the type accessing the interface to implement non-public function from the interface, meeting the features included in the contract of the interface; and
an act of generating a software application using the non-public function of the type including the features of the contract of the interface and at least one public function, as indicated in the received user input.

20. The computer program product of claim 19, wherein at least some portions of source code for the generated application are inherited from a plurality of sources.
